(19) United States
(12) Patent Application Publication
(10) Pub. No.: US 2020/0048893 A1
(43) Pub. Date: Feb. 13, 2020

(54) Control System for Movable Additive Manufacturing

(71) Applicant: Caterpillar Inc., Deerfield, IL (US)

(72) Inventors: Daniel J. Martinez, Peoria, IL (US); Zhijun Cai, Dunlap, IL (US); Daniel P. Sergison, East Peoria, IL (US)

(73) Assignee: Caterpillar Inc., Deerfield, IL (US)

(21) Appl. No.: 16/058,085

(22) Filed: Aug. 8, 2018

(51) Int. Cl. E04B 1/35; B33Y 10/00; B33Y 30/00; B33Y 50/02; E04B 1/16

(52) U.S. Cl. CPC E04B 1/3505; B33Y 10/00; E04B 2103/02; B33Y 50/02; E04B 1/161; B33Y 30/00

(57) ABSTRACT

A system for additive manufacturing includes a mobile implement system with a nozzle, an implement system pose sensor, and a controller. The controller determines a plurality of potential poses and a plurality of potential paths of the nozzle. A desired pose and a desired path are selected and a sequence and rate of operation of the mobile implement system is determined to permit the nozzle to deposit sequential layers of material to form a desired structure. After moving the mobile implement system towards the desired pose, a modified sequence and rate of operation of the mobile implement system is determined that will cause the nozzle to follow the desired path even if the mobile implement system is not at the desired pose while depositing the sequential layers of material along the desired path to form the structure.

### TECHNICAL FIELD

This disclosure relates generally to a system for controlling an additive manufacturing process and, more particularly, to a system and method of controlling a movable implement system for use in additive manufacturing.

### BACKGROUND

Objects may be formed using additive manufacturing processes by applying or generating sequential layers of material to form the object. In some systems, the objects are formed by solidifying material within a container with the object being formed moving downward within the container after forming each layer. In other processes, layers of material are sequentially deposited on previously formed layers.

While such additive manufacturing processes are generally used within factories, laboratories, and other similar enclosed facilities, machines have been developed for applying additive manufacturing processes in other environments. However, using additive manufacturing outside the controlled environment of a factory or laboratory presents additional difficulties in generating high quality and accurate objects.

U.S. Pat. No. 9,464,405 discloses an excavator configured for additive manufacturing. The excavator includes a implement system having a linkage system and a nozzle for depositing material in layers to form an object or structure. In addition to the course adjustment of the position of the nozzle provided by the linkage system, a further mechanism is provided for fine adjustment of the position of the nozzle.

The foregoing background discussion is intended solely to aid the reader. It is not intended to limit the innovations described herein, nor to limit or expand the prior art discussed. Thus, the foregoing discussion should not be taken to indicate that any particular element of a prior system is unsuitable for use with the innovations described herein, nor is it intended to indicate that any element is essential in implementing the innovations described herein. The implementations and application of the innovations described herein are defined by the appended claims.

### SUMMARY

In one aspect, a system for additive manufacturing a structure at a work site includes a mobile implement system, an implement system pose sensor, and a controller. The mobile implement system has a linkage assembly including a nozzle configured to deposit sequential layers of material to form the structure. The implement system pose sensor generates implement system pose signals indicative of a pose of the mobile implement system. The controller is configured to access a site map of the work site, access a model of the structure to be manufactured, and access a kinematic model and operating characteristics of the mobile implement system. The controller is further configured to determine a plurality of potential poses of the mobile implement system at the work site based upon the site map and the model of the structure and for each potential pose, determine a plurality of potential paths of the nozzle to form at least a portion of the structure by depositing a plurality of sequential layers of material based upon the site map, the model of the structure, the kinematic model and operating characteristics of the mobile implement system. The controller is also configured to select a desired pose of the mobile implement system from the plurality of potential poses and a desired path of the nozzle from the plurality of potential paths, determine a first sequence and rate of operation of the mobile implement system based upon the desired path of the nozzle and the kinematic model and the operating characteristics of the mobile implement system, with the first sequence and rate of operation of the mobile implement system causing the nozzle to follow the desired path while the mobile implement system is at the desired pose, generate a movement command to move the mobile implement system towards the desired pose, determine a current pose of the mobile implement system at the work site based upon the implement system pose signals, and determine a difference between the current pose and the desired pose. Based upon at least the difference between the current pose and the desired pose, the controller generates a modified sequence and rate of operation of the mobile implement system the modified sequence and rate of operation of the mobile implement system causing the nozzle to follow the desired path while the mobile implement system is at the current pose and generates command instructions to move the nozzle along the desired path to deposit the sequential layers of material along the desired path to form the at least a portion of the structure.

In another aspect, a method of depositing sequential layers of material to form a structure at a work site using a mobile implement system having a linkage assembly including a nozzle includes accessing a site map of the work site, accessing a model of the structure to be manufactured, accessing a kinematic model and operating characteristics of the mobile implement system, and determining a plurality of potential poses of the mobile implement system at the work site based upon the site map and the model of the structure. For each potential pose, the method includes determining a plurality of potential paths of the nozzle to form at least a portion of the structure by depositing a plurality of sequential layers of material based upon the site map, the model of the structure, the kinematic model and operating characteristics of the mobile implement system, and then selecting a desired pose of the mobile implement system from the plurality of potential poses and a desired path of the nozzle from the plurality of potential paths and determining a first sequence and rate of operation of the mobile implement system based upon the desired path of the nozzle and the kinematic model and the operating characteristics of the mobile implement system, with the first sequence and rate of operation of the mobile implement system causing the nozzle to follow the desired path while the mobile implement system is at the desired pose. The method also includes generating a movement command to move the mobile implement system towards the desired pose, determining a current pose of the mobile implement system at the work site based upon implement system pose signals from an implement system pose sensor indicative of a pose of the mobile implement system, determining a difference between the current pose and the desired pose, generating a modified sequence and rate of operation of the mobile implement system based upon at least the difference between the current pose and the desired pose, with the modified sequence and rate of operation of the mobile implement system causing the nozzle to follow the desired path while the mobile implement system is at the current pose, and generating command instructions to move the nozzle along the desired path to deposit the plurality of sequential layers of material along the desired path to form the at least a portion of the structure.

In still another aspect, a movable machine includes a traction device, an implement system, an implement system pose sensor, and a controller. The traction device is configured to propel the movable machine about a work site. The implement system has a linkage assembly including a nozzle configured to deposit sequential layers of material to form the structure. The implement system pose sensor generates implement system pose signals indicative of a pose of the implement system. The controller is configured to access a site map of the work site, access a model of the structure to be manufactured, and access a kinematic model and operating characteristics of the implement system. The controller is further configured to determine a plurality of potential poses of the implement system at the work site based upon the site map and the model of the structure and for each potential pose, determine a plurality of potential paths of the nozzle to form at least a portion of the structure by depositing a plurality of sequential layers of material based upon the site map, the model of the structure, the kinematic model and operating characteristics of the implement system. The controller is also configured to select a desired pose of the implement system from the plurality of potential poses and a desired path of the nozzle from the plurality of potential paths, determine a first sequence and rate of operation of the implement system based upon the desired path of the nozzle and the kinematic model and the operating characteristics of the implement system with the first sequence and rate of operation of the implement system causing the nozzle to follow the desired path while the implement system is at the desired pose, generate a movement command to move the implement system towards the desired pose, determine a current pose of the implement system at the work site based upon the implement system pose signals, and determine a difference between the current pose and the desired pose. Based upon at least the difference between the current pose and the desired pose, the controller generates a modified sequence and rate of operation of the implement system the modified sequence and rate of operation of the implement system causing the nozzle to follow the desired path while the implement system is at the current pose and generates command instructions to move the nozzle along the desired path to deposit the sequential layers of material along the desired path to form the at least a portion of the structure.

### BRIEF DESCRIPTION OF THE DRAWINGS

FIG. 1 depicts a diagrammatic illustration of an excavator configured for additive manufacturing incorporating the principles disclosed herein;

FIG. 2 depicts a simplified schematic of a control system within the excavator of FIG. 1;

FIG. 3 depicts an enlarged diagrammatic view of a nozzle and inspection system while depositing a layer of material;

FIG. 4 depicts an a diagrammatic view of the nozzle depositing a layer of material as viewed along the layer of material;

FIG. 5 depicts a flowchart illustrating an additive manufacturing process; and

FIG. 6 depicts a flowchart illustrating an alternate aspect of the process of FIG. 5.

### DETAILED DESCRIPTION

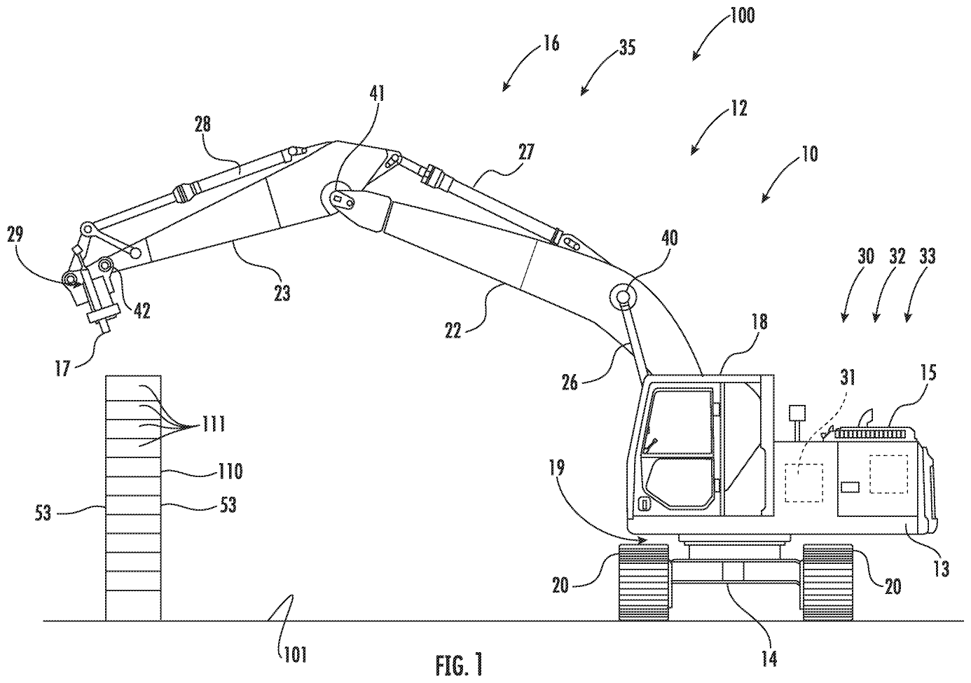

FIG. 1 illustrates an exemplary work site 100 at which one or more machines 10 such as hydraulic excavators may operate in an autonomous, a semi-autonomous, or a manual manner. Work site 100 may include, for example, a construction site, a road work site, a mine site, a landfill, a quarry, or any other type of site. The machines 10 may perform desired operations or tasks at the work site 100 such as forming structures using additive manufacturing techniques or processes. In doing so, the machines 10 may sequentially apply or deposit layers 111 of material to ultimately form a desired object or structure 110. As an example, machine 10 may be configured to deposit layers 111 of concrete material to form all or a portion of a building or other structure 110.

The machine 10 is depicted as a hydraulic excavator having multiple systems and components that cooperate to perform the desired additive manufacturing operation. The machine 10 may include an implement system 12 comprising a swing member or platform 13, an undercarriage 14, a prime mover 15, and a linkage assembly 16 including a work implement configured as a nozzle 17 for additive manufacturing. The platform 13 may be rotatably disposed on undercarriage 14 and may include an operator station 18 from which an operator may control some or all of the operations of the machine 10. Rotation of the platform 13 relative to the undercarriage 14 may be effected by a swing motor 19.

The undercarriage 14 may be a structural support for one or more traction devices 20 configured as ground engaging tracks operative to allow translational motion of the machine 10 across a work surface 101 and thus permit the implement system 12 to be a movable implement system. Alternatively, the traction devices 20 may be configured as wheels, belts, or other traction devices known in the art.

The prime mover 15 may provide power for the operation of the machine 10. The prime mover 15 may embody a combustion engine, such as a diesel engine, a gasoline engine, a gaseous fuel powered engine (e.g., a natural gas engine), or any other type of combustion engine known in the art. The prime mover 15 may alternatively embody a non-combustion source of power, such as a fuel cell or a power storage device such as a battery coupled to a motor. The prime mover 15 may provide a rotational output to drive the traction devices 20, thereby propelling the machine 10. The prime mover 15 may also provide power to other systems and components of the machine 10.

The linkage assembly 16 may include one or more linkage members configured to move the nozzle 17. In one example, the linkage assembly 16 may include a boom member 22 and a stick member 23. A first end of the boom member 22 may be pivotally connected to the platform 13, and a second end of the boom member may be pivotally connected to a first end of the stick member 23. The nozzle 17 may be pivotally or movably connected to a second end of stick member 23.

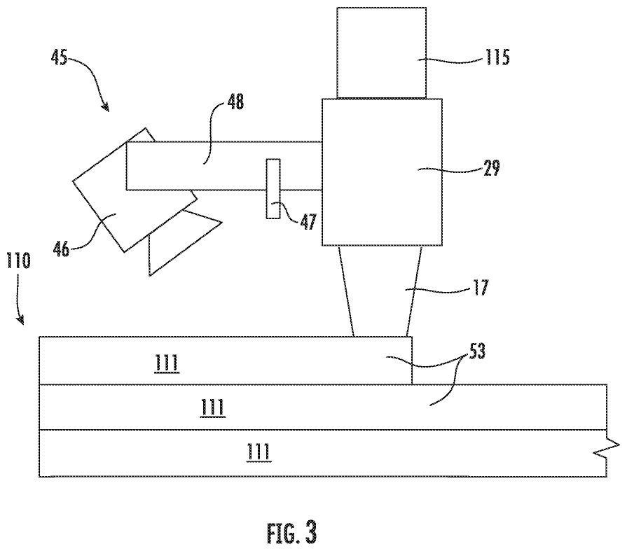

Each linkage member may include and be operatively connected to one or more actuators such as hydraulic cylinders. More specifically, the boom member 22 may be propelled or moved along a path by one or more boom hydraulic cylinders 26 (only one being shown in FIG. 1). The stick member 23 may be propelled by a stick hydraulic cylinder 27. Rotation of the nozzle 17 relative to the stick member 23 may be effected by a work implement hydraulic cylinder 28. The linkage members may translate or rotate in a plane that is generally orthogonal to the work surface 101. If desired, the nozzle 17 may be configured for additional movement relative to the stick member 23 with an additional nozzle positioning mechanism, indicated generally at 29 in FIG. 3, that provides additional and/or fine adjustment of the position of the nozzle. An example of such an additional nozzle positioning mechanism 29 is described in more detail in U.S. Pat. No. 9,464,405.

Each of the boom hydraulic cylinders 26, the stick hydraulic cylinder 27, and the work implement hydraulic cylinder 28 may embody a linear actuator having a tubular or cylindrical body and a piston and rod assembly therein arranged to form two distinct pressure chambers. The pressure chambers may be selectively supplied with pressurized fluid and drained of the pressurized fluid to cause the piston and rod assembly to displace within the cylindrical body, and thereby change the effective length of the hydraulic cylinders. The flow rate of fluid into and out of the pressure chambers may relate to the speed of extension or retraction of the hydraulic cylinders 26, 27, 28, while a pressure differential between the two pressure chambers may relate to the force imparted by the hydraulic cylinders to their associated linkage members. The extension and retraction of the hydraulic cylinders results in the movement of the nozzle 17. It is also contemplated that the actuators may alternatively embody electric motors, pneumatic motors, or any other actuation devices.

The swing motor 19 may also be driven by differential fluid pressure. Specifically, the swing motor 19 may be a rotary actuator including first and second chambers (not shown) located on opposite sides of an impeller (not shown). By filling one chamber with pressurized fluid and draining the other chamber of fluid, the impeller is urged to rotate. The flow rate of fluid into and out of the first and second chambers affects the rotational speed of swing motor 19, while a pressure differential across the impeller affects the output torque thereof.

Machine 10 may be controlled by a control system 30 as shown generally by an arrow in FIG. 1 indicating association with the machine. The control system 30 may include an electronic control module or controller 31 and a plurality of sensors. The controller 31 may control the operation of various aspects of the machine 10 including the drivetrain and the hydraulic systems.

The controller 31 may be an electronic controller that operates in a logical fashion to perform operations, execute control algorithms, store and retrieve data and other desired operations. The controller 31 may include or access memory, secondary storage devices, processors, and any other components for running an application. The memory and secondary storage devices may be in the form of read-only memory (ROM) or random access memory (RAM) or integrated circuitry that is accessible by the controller. Various other circuits may be associated with the controller 31 such as power supply circuitry, signal conditioning circuitry, driver circuitry, and other types of circuitry.

The controller 31 may be a single controller or may include more than one controller disposed to control various functions and/or features of the machine 10. The term “controller” is meant to be used in its broadest sense to include one or more controllers and/or microprocessors that may be associated with the machine 10 and that may cooperate in controlling various functions and operations of the machine. The functionality of the controller 31 may be implemented in hardware and/or software without regard to the functionality. The controller 31 may rely on one or more data maps relating to the operating conditions and the operating environment of the machine 10 and the work site 100 that may be stored in the memory of or associated with the controller. Each of these data maps may include a collection of data in the form of tables, graphs, and/or equations.

The control system 30 and the controller 31 may be located on the machine 10 as an on-board control system with an on-board controller or may be distributed with components located remotely from the machine. The functionality of control system 30 may be distributed so that certain functions are performed at the machine 10 and other functions are performed remotely. In such case, the control system 30 may include a communications system such as a wireless communications system for wireless communication (e.g., transmitting and receiving signals) between the machine 10 and a system located remote from the machine.

Machine 10 may be configured to be operated autonomously, semi-autonomously, or manually. As used herein, a machine 10 operating in an autonomous manner operates automatically based upon information received from various sensors without the need for human operator input. As an example, a load or haul truck that automatically follows a path from one location to another and dumps a load at an end point may be operating autonomously. A machine operating semi-autonomously includes an operator, either within the machine or remotely, who performs some tasks or provides some input, and other tasks are performed automatically and may be based upon information received from various sensors. As an example, a haul truck that automatically follows a path from one location to another but relies upon an operator command to dump a load may be operating semi-autonomously. In another example of a semi-autonomous operation, an operator may dump a bucket of an excavator in a haul truck and a controller may automatically return the bucket to a position to perform another digging operation. A machine being operated manually is one in which an operator is controlling all or essentially all of the functions of the machine. A machine may be operated remotely by an operator (i.e., remote control) in either a manual or semi-autonomous manner.

Machine 10 may be equipped with a plurality of sensors that provide data indicative (directly or indirectly) of various operating parameters of the machine and/or the operating environment in which the machine is operating. The term “sensor” is meant to be used in its broadest sense to include one or more sensors and related components that may be associated with the machine 10 and that may cooperate to sense various functions, operations, and operating characteristics of the machine and/or aspects of the environment in which the machine is operating.

An implement system pose sensing system 35, as shown generally by an arrow in FIG. 1 indicating association with the machine 10, includes an implement system pose sensor 36 to sense the position and orientation (i.e., the heading, pitch, roll or tilt, and yaw) of the implement system 12 relative to the work site 100. The position and orientation are sometimes collectively referred to as the pose. The implement system pose sensor 36 may include a plurality of individual sensors that cooperate to generate and provide pose signals to the controller 31 indicative of the position and orientation of the implement system 12.

In one example, the implement system pose sensor 36 may include one or more sensors that interact with a positioning system such as a global navigation satellite system or a global positioning system to operate as a pose sensor. In another example, the implement system pose sensor 36 may further include a slope or inclination sensor such as a pitch angle sensor for measuring the slope or inclination of the implement system 12 relative to a ground or earth reference. The controller 31 may use the implement system pose signals from the implement system pose sensor 36 to determine the pose of the implement system 12 within work site 100. In other examples, the implement system pose sensor 36 may include an odometer or another wheel rotation sensing sensor, a perception based system, or may use other systems such as lasers, sonar, or radar to determine all or some aspects of the pose of implement system 12.

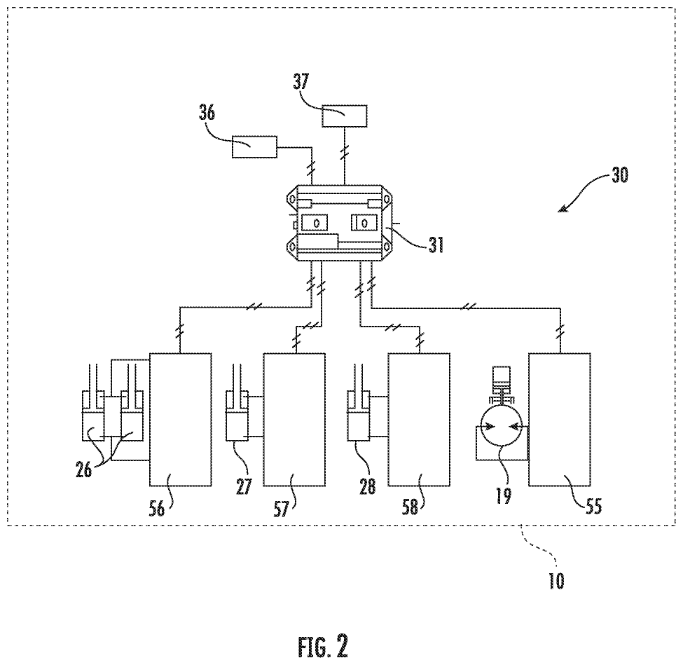

The implement system pose sensor 36 may include a plurality of angle sensors 37 (indicated separately from the implement system pose sensor 36 in FIG. 2) located near one or more joints of the linkage members (i.e., the boom joint 40 between the platform 13 and the boom member 22, the stick joint 41 between the boom member 22 and the stick member 23, and the implement joint 42 between the nozzle 17 and the stick member 23), and between the platform 13 and the undercarriage 14. The angle sensors 37 may include rotary encoders, potentiometers, or other angle or sensing devices for measuring the relative angular position of components. In an alternate embodiment, the angle sensors 37 may measure the displacement of an actuator and the joint angles may be calculated based upon the position of the actuators and the dimensions of the linkage members. In another alternate embodiment, any or all of the angle sensors 37 may be configured to measure an angular velocity or an angular acceleration rather than angular position. Regardless of the type of the angle sensors 37, the controller 31 may use output signals from the angle sensors to determine the state of aspects of implement system 12, such as, for example, the position, the velocity, the acceleration, the angle, the angular velocity, and the angular acceleration of each linkage member and the nozzle 17, as well as the angle, the angular velocity, and the angular acceleration of the platform 13 relative to undercarriage 14.

The positions of the components of the machine 10 including the implement system 12 may be determined based upon the kinematic model of the machine together with the dimensions of the platform 13, undercarriage 14, boom member 22, stick member 23, and nozzle 17, as well as the relative positions between the various components. More specifically, the controller 31 may include a data map that identifies the position of each component of the machine 10 based upon the relative positions between the various components. The controller 31 may use the dimensions and the positions of the various components to generate and store therein a three-dimensional electronic map of the machine 10 at the work site 100. In addition, by knowing the speed or acceleration of certain components, the speed or acceleration of other components of the machine 10 may be determined.

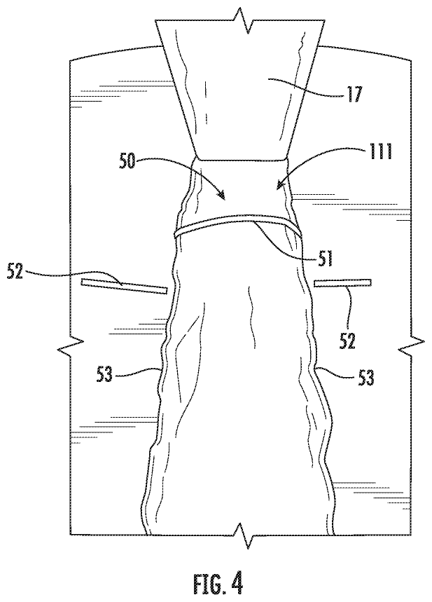

As best shown in FIGS. 3-4, an inspection system 45 is disposed or positioned proximate to the nozzle 17. The inspection system 45 may be, but is not limited to, an optical system (e.g., a camera), a thermal or infrared imaging system, or another system operative to detect characteristics of the layers 111 of material as they exit the nozzle 17 and are deposited in a desired location such as on a previously formed layer. Inspection system 45 is depicted as an optical system with a camera system 46 and a light source 47 that extends along a cantilevered beam 48 adjacent the nozzle 17. The camera system 46 may be a single camera, as depicted, or include multiple cameras. The camera system 46 may be disposed at an angle (e.g., 45 degrees) to the surface of the layer 111 of material being deposited and to the light source 47.

The light source 47 may be provided to increase or emphasize the contrast between components adjacent the nozzle 17. In one embodiment, the light source 47 is operative to generate a light beam configured as a line 50 (FIG. 4) with a relatively narrow width and a specified length. As depicted, the light source 47 is disposed or oriented so that the line 50 extends transverse to the layer 111 of material being deposited and has a length greater than the width of the layer. More specifically, the line 50 has a first or central section 51 that is projected onto or illuminates the upper surface of the layer 111 and two outer sections 52 that project beyond the sides 53 of the layer.

The cantilevered beam 48 may be a rigid member that extends from the nozzle 17 or the additional nozzle positioning mechanism 29 and parallel to the layer 111 of material being deposited. By positioning the cantilevered beam 48 along the layer 111 of material with the camera system 46 and the light source 47 thereon, a relatively high contrast image of the edges of the layer of material may be captured by the camera system as the nozzle 17 deposits the layer of material.

Material may be supplied by a pump (not shown) from a source or tank (not shown) through a hose 115 (FIG. 3) operatively connected to the nozzle 17. In some embodiments, depending on the configuration of the nozzle 17 and the material being deposited, the flowability or slump of the material may be selected so that the thickness of each deposited layer 111 of material is generally controlled by the height of the nozzle 17 above the last deposited layer of material. However, the characteristics of the material are such that the width of each layer 111 is dependent upon the rate at which the material is being pumped through the nozzle 17 and the rate at which the nozzle is moving along its desired path. Thus, the width of a layer 111 of material may be controlled by altering either or both of the rate at which the material is fed through the nozzle and the rate at which the nozzle 17 is moved along its path by the implement system 12.

Due to the nature of pumping the concrete material from the source or tank and through the hose 115, in some applications, adjusting the rate at which the material may be pumped may be a relatively imprecise process. In addition, since the pump is typically located at or near the source or tank and/or due to the nature of a typical pump, adjustments to the operation of the pump may not be immediately reflected in changes to the flow rate of material from the nozzle 17. Accordingly, in some applications, it may be desirable to control the width of the layer 111 of material by controlling the rate at which the nozzle 17 is moved along its desired path.

To do so, the image data captured by the inspection system 45 can be analyzed by the controller 31 to determine the width of the layer 111 of material being deposited. The controller 31 may compare the width of the layer 111 being deposited as determined from the captured digital images to the specification or model of the desired object or structure 110. If the width of the deposited layer 111 varies from the specification or model (beyond a desired threshold or tolerance), the controller 31 may modify the command instructions to change the rate at which the nozzle 17 moves along the desired path and thus change the width of the layer of material being deposited.

Through such a process, the information acquired by the inspection system 45 may be used by the controller 31 to control the additive manufacturing process and improve the quality of the object or structure 110 or improve the efficiency of the manufacturing process.

Referring back to FIG. 2, the swing motor 19, the boom hydraulic cylinders 26, the stick hydraulic cylinder 27, and the work implement hydraulic cylinder 28 may function together with other cooperating fluid components to move the nozzle 17 in response to input received from the controller 31. In particular, the control system 30 may include one or more fluid circuits (not shown) operatively connected to the swing motor 19 and the hydraulic cylinders 26, 27, 28 and configured to produce and distribute streams of pressurized fluid. A swing control valve 55, a boom control valve 56, a stick control valve 57, and a work implement control valve 58 may be situated to receive the streams of pressurized fluid and selectively meter the fluid to and from the swing motor 19, the boom hydraulic cylinders 26, the stick hydraulic cylinder 27, and the work implement hydraulic cylinder 28, respectively, to regulate the motions thereof.

Signals from the controller 31 are operative to direct operation of the swing control valve 55, the boom control valve 56, the stick control valve 57, and the work implement control valve 58 based on the data maps stored within or accessed by the controller 31. More specifically, the controller 31 may generate command signals based on a desired path and/or speed of the nozzle 17 in a particular direction, and reference the data maps stored in the memory of the controller 31 to determine flow rate values and/or associated positions for each of the supply and drain elements within the swing control valve 55, the boom control valve 56, the stick control valve 57, and the work implement control valve 58. The flow rates or positions may then be commanded of the appropriate supply and drain elements to cause filling and/or draining of the chambers of the actuators at rates that result in the desired movement of the nozzle 17.

Control system 30 may also include a module or planning system, generally indicated at 32 in FIG. 1, for determining or planning various aspects of the mobile additive construction process. The planning system 32 may receive various types of input such as the configuration or site map of the work site 100, a model of the object or structure 110 to be formed, the number and types of machines 10 being used to form the object or structure and a kinematic model and operating characteristics of each machine, together with the expected flow rate, the thickness of each layer 111, and the material characteristics of the material used to form the object or structure.

The planning system 32 may utilize all or some of the inputs to determine a desired path for movement of the nozzle 17 relative to the work site 100 in order to form the desired object or structure 110. In addition, due to the position and characteristics of the pump, the source or tank, and the material, it is typically desirable for the nozzle 17 to follow a path that permits the material to continuously flow through the nozzle. Attempting to turn on and off the flow of material through the nozzle 17 will typically result in an inefficient and/or more complex manufacturing process.

Based upon the desired path, the planning system 32 may determine a desired pose of the implement system 12 and a desired sequence and manner or rate of operation of the implement system 12 so that the nozzle 17 follows the desired path. More specifically, the planning system 32 may determine both a pose of the implement system 12 and the sequence and manner or rate of operation of swing control valve 55, the boom control valve 56, the stick control valve 57, and the work implement control valve 58 to control the movement of the swing motor 19, the boom hydraulic cylinders 26, the stick hydraulic cylinder 27, and the work implement hydraulic cylinder 28 to control the movement of the nozzle 17 so that it travels along the desired path and at the desired rate. If the implement system 12 includes an additional nozzle positioning mechanism 29, the planning system 32 may further determine the sequence and manner of operation of the additional nozzle positioning mechanism while directing the nozzle 17 to move along the desired path. The path of the nozzle 17 and the sequence and manner or rate of operation of the implement system 12 may be stored within or accessed by the controller 31 as desired.

During the planning process, the planning system 32 may also receive or access one or more desired optimization parameters that may be used to prioritize or weigh different aspects of the manufacturing process. Such optimization parameters may include the manufacturing cost, the manufacturing time, as well as maintaining a continuous flow of material through the nozzle.

For example, in one embodiment, the planning system 32 may be configured to optimize the manufacturing process for the lowest cost. In doing so, the planning system 32 may be provided with a cost of machine operation (i.e., machine cost) such as a cost per hour for the time of operation and a material cost based upon a volume of material used. The planning system 32 may then generate an optimized plan (e.g., the desired path of the nozzle 17 as well as the sequence and manner or rate of operation of the implement system 12) that will result in the lowest cost (e.g., lowest cost pose and lowest cost path) to manufacture the desired object or structure 110.

In another embodiment, the planning system 32 may be configured to optimize the manufacturing process for the shortest time. In doing so, the planning system 32 may optimize the manufacturing speed without regard to the cost of the manufacturing process. As an example, the planning system 32 may be configured to generate a plan utilizing two or more machines 10 to simultaneously perform the manufacturing operation when a single machine could be operated in a more cost effective manner. Further, the planning system 32 may direct material to be processed or utilized in a manner that is not as efficient or cost effective as possible but will maximize the machine operation in order to complete the manufacturing process as quickly as possible. Sill further, the characteristics of the concrete material may be selected or designated to minimize the set time or amount of sag of the material even at the risk of wasting material or incurring additional costs for the material.

In still another embodiment, the planning system 32 may be configured to ensure that the path for the nozzle 17 permits the continuous flow of material. By using a continuous flow of material, processes or structures for interrupting the flow of material, such as turning the pump on and off or the use of a complex valve assembly are not required.

In other embodiments, a combination of the optimization parameters may be used in order to provide a desired balance between cost and speed as well as any other desired optimization parameters.

In operation, after determining the desired path of the nozzle 17 and the resulting desired pose and desired sequence and rate of operation of the implement system 12, the machine 10 may be moved or driven at the work site 100 to generally position the implement system 12 at the desired pose. Due to the size of the machine 10, limitations on the ability to make small adjustments in position as a result of the configuration of the undercarriage and traction devices 20, differences between the expected and actual topography of the work site 100, and other factors, the actual or current pose of the implement system 12 may not sufficiently match the desired or optimized pose so that the structure 110 is manufactured or formed in the desired position.

As a result of the difference in pose of the implement system 12, the control system 30 may further include a dynamic compensation system, generally indicated at 33 in FIG. 1, for modifying the path of the nozzle 17 relative to the implement system 12 to compensate for the differences between the desired pose and the actual or current pose. More specifically, the dynamic compensation system 33 may determine a new or modified sequence and rate of operation of the implement system 12 so that the nozzle 17 follows the same path relative to the work site 100 as if the implement system were positioned at the desired pose.

In other words, the dynamic compensation system 33 may modify the sequence and rate of operation of the implement system 12 so that the nozzle 17 continues to follow the desired path of the nozzle even though the machine 10 and implement system 12 are not in the position as desired or planned by the planning system 32. In doing so, the dynamic compensation system 33 maintains the desired path of the nozzle 17 relative to the work site 100 but determines a new path for the nozzle 17 relative to the current pose of the implement system 12. The dynamic compensation system 33 thus generates a new or modified sequence and rate of operation of the implement system 12 so that the nozzle 17 follows the desired path even though the implement system has a pose that is different from that which was planned.

In some instances, the dynamic compensation system 33 may not be able to adjust or modify the movement of the implement system 12 so that the path of the nozzle 17 continues to follow the desired path as planned by the planning system 32. In such case, the controller 31 may generate movement commands or instructions to move the machine 10 so that the implement system 12 may be operated with the nozzle 17 following the desired path. In other instances, the controller 31 may determine that it is desirable (e.g., less costly or faster) to move the machine 10 to a new location so that the implement system 12 may be operated with the nozzle 17 following the desired path. In either case, the dynamic compensation system 33 may modify the sequence and rate of operation of the implement system 12 so that the nozzle 17 continues to follow the desired path for the nozzle.

In some embodiments, depending on the configuration of the nozzle 17 and the material being deposited, the thickness of each deposited layer 111 is generally controlled by the height of the nozzle 17 above the last deposited layer of material. However, the characteristics of the material are such that the width of each layer 111 is dependent upon the rate at which the material is being pumped through the nozzle 17 and the rate at which the nozzle is moving along its desired path. Thus, the width of a layer 111 of material may be controlled by altering either or both of the rate at which the material is fed through the nozzle and the rate at which the nozzle 17 is moved along its path by the implement system 12.

Due to the nature of pumping the concrete material from a source or tank (not shown) and through a hose 115 (FIG. 3), in some applications, adjusting the rate at which the material may be pumped may be a relatively imprecise process. Accordingly, in some applications, it may be desirable to control the width of the layer 111 of material by controlling the rate at which the nozzle 17 is moved along its desired path.

To do so, the image data captured by the inspection system 45 can be analyzed by the controller 31 to determine the width of the layer 111 of material being deposited. The controller 31 may compare the width of the layer 111 being deposited as determined from the captured digital images to the specification or model of the desired object or structure 110. If the width of the deposited layer 111 varies from the specification or model (beyond a desired threshold or tolerance), the controller 31 may modify the command instructions to change the rate at which the nozzle 17 moves along the desired path and thus change the width of the layer of material being deposited.

Through such a process, the information acquired by the inspection system 45 may be used by the controller 31 to control the additive manufacturing process and improve the quality of the object or structure 110 or improve the efficiency of the manufacturing process.

### INDUSTRIAL APPLICABILITY

The industrial applicability of the systems described herein will be readily appreciated from the forgoing discussion. The foregoing discussion is applicable to machines 10, such as an excavator, that operates at a work site 100 to form a desired object or structure 110 using an additive manufacturing process. The systems and processes disclosed herein may be used at a construction site, a roadwork site, a mining site, a quarry, a landfill, or any type of site or setting in which it is desired to form an object or structure. By utilizing a machine 10, such as an excavator, for an additive manufacturing process, objects or structures may be formed out of a durable material such as concrete at remote locations without the need for materials necessary to create complex forms. For example, the systems and processes disclosed herein may be used to form buildings in relatively remote locations. In another example, the systems and processes disclosed herein may be used to form plumbing junction boxes at a construction or road work site. The large size of such junction boxes makes off-site manufacturing and transportation relatively complex and expensive. In addition, the junction boxes may have a relatively complex shape which is ideally suited for additive manufacturing.

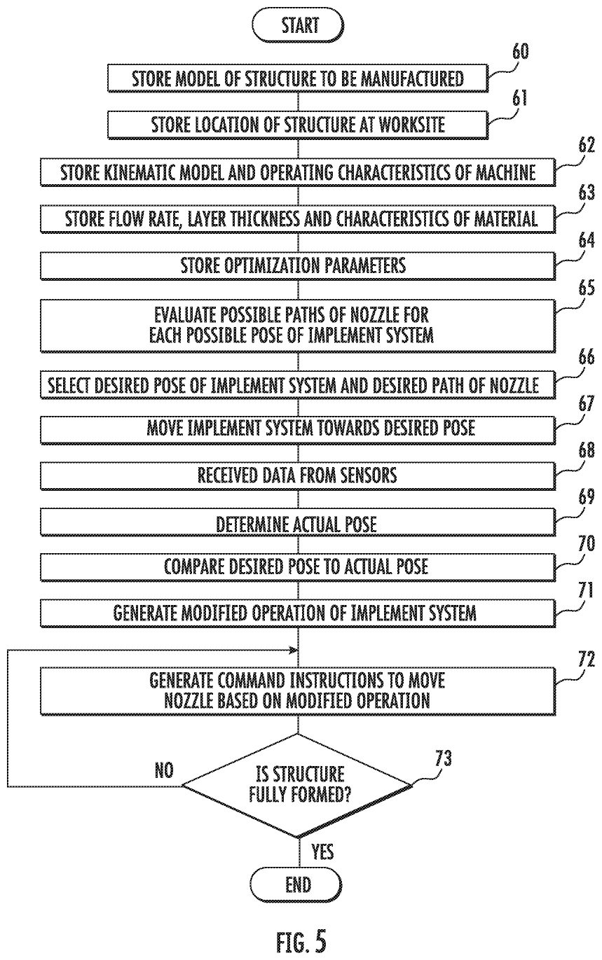

FIG. 5 depicts a flowchart of one example of a process for additive manufacturing using a machine 10 such as an excavator. At stage 60, a model of the object or structure 110 to be formed may be stored or set within the controller 31. An electronic map of the work site 100 together with the location at which the structure 110 is to be formed may be stored or set within the controller 31 at stage 61. A kinematic model and operating characteristics of the machine 10 may be stored or set at stage 62 within the controller 31. The kinematic model and operating characteristics of the machine 10 may include the dimensions of the machine, the types of possible or acceptable motions of the undercarriage 14 and the traction devices 20, the desired ranges of fluid flow rates, and the desired ranges of movement, velocities, and accelerations of the implement system 12 and its individual components.

A flow rate of the material to be deposited by the nozzle 17, the thickness of each layer 111 of material to be deposited and other characteristics of the material may be set or stored within the controller 31 at stage 63. Examples of the other characteristics of the material may include the set rate or minimum time required between layers and the “sag” rate or the number of layers that may be deposited on top of another layer within a specified period of time. Additional characteristics of the material may include the time required to produce a batch of material and the duration or time period in which a batch of material is usable for the manufacturing process.

At stage 64, optimization parameters may be set or stored. In one example, optimization parameters may include costs associated with each aspect of the additive manufacturing process including machine charges for each aspect of the manufacturing process as well as material costs based upon the amount and type of material. In another example, optimization parameters may include the time required for each aspect of the manufacturing process.

A plurality of potential poses of the implement system 12 may be determined at stage 65 together with a plurality of potential paths of the nozzle 17 to manufacture at least a portion of the object or structure 110 being formed by the process of depositing sequential layers of material. The controller 31 may utilize the model of the structure 110 as stored at stage 60, the location of the structure at the work site 100 as stored at stage 61, the kinematic model and operating characteristics of the machine 10 as stored at stage 62, and the flow rate of the material, the thickness of each layer 111, and other characteristics of the material as stored at stage 63. In addition, if desired, the optimization parameters as stored at stage 64 may also be utilized.

At stage 66, the controller 31 may select an optimized or desired pose of the implement system 12 corresponding to the desired path of the nozzle 17 to form the structure 110. In doing so, the controller 31 may determine the sequence and rate of operation of the implement system 12 based upon the desired pose and the desired path. The machine 10 together with the implement system 12 may be moved towards the desired pose at stage 67. Implement system pose signals may be received from the implement system pose sensor 36 at stage 68. At stage 69, the controller 31 may determine the actual or current pose of the implement system 12.

The controller 31 may compare the current pose to the desired pose of the implement system 12 at stage 70 and determine at stage 71 a modified sequence and rate of operation of the implement system so that the nozzle 17 follows the desired path relative to the work site 100 even though the machine 10 and the implement system 12 are not in the position as expected or planned by the planning system 32 of the controller 31. To do so, the controller 31 may generate a modified sequence and rate of operation of the implement system 12 as compared to the original sequence and rate of operation since the nozzle 17 is following the same desired path but the implement system is at a different pose as compared to the desired pose.

At stage 72, the controller 31 may generate command instructions to operate the implement system 12 in order to move the nozzle 17 along the desired path and deposit layers 111 of material based upon the modified sequence and rate of operation. The controller may determine at decision stage 73 whether the structure 110 has been fully formed. If the structure 110 has not been fully formed, the controller 31 may continue to generate command instructions to move the nozzle 17 along the desired path at stage 72.

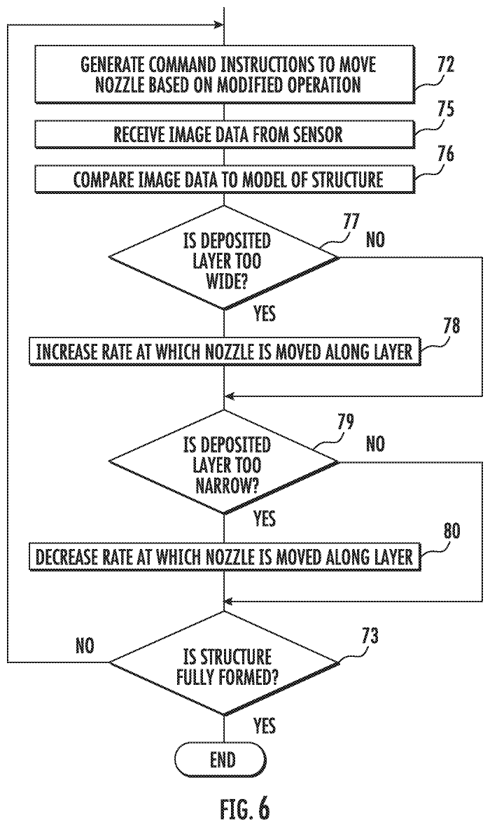

In some instances, it may be desirable to monitor the width of the deposited layer 111 of material as it is being applied at the work site 100. To do so, the process set forth in the flowchart of FIG. 6 may be followed between stages 72-73. At stage 75, the controller 31 may receive image data from the inspection system 45. The controller 31 may compare at stage 76 the image data to the model of the structure stored within the controller.

At decision stage 77, the controller 31 may determine whether the deposited layer 111 is wider than desired based upon the stored model. If the deposited layer 111 is wider than desired, the controller 31 may modify the sequencing and rate of operation of the implement system 12 so that the nozzle 17 moves along the desired path at a higher or faster rate at stage 78. As a result of the increased rate, less material will be deposited per unit length which will result in a narrower layer 111 of material being deposited.

If the deposited layer 111 is not wider than desired at decision stage 77 or the controller has increased at stage 78 the rate at which the nozzle 17 is moving along the deposited layer, the controller 31 may determine at decision stage 79 whether the deposited layer 111 is narrower than desired based upon the stored model. If the deposited layer 111 is narrower than desired, the controller 31 may modify the sequencing and rate of operation of the implement system 12 at stage 80 so that the nozzle 17 moves along the desired path at a lower or slower rate. As a result of the decreased rate, more material will be deposited per unit length which will result in a wider layer 111 of material being deposited. If the deposited layer 111 is not narrower than desired at decision stage 79 or the controller has decreased at stage 80 the rate at which the nozzle 17 is moving along the deposited layer, the process of stages 75-79 is repeated until the structure 110 is fully formed as described above.

Various alternative configurations and processes are contemplated. For example, although the process of stages 60-73 and 75-80 is described in the context of utilizing a single machine 10, two or more machines may be used either in parallel or sequentially to form the structure 110. For example, two or more machines 10 may be operating at the work site 100 with each machine being responsible for manufacturing a different portion of the structure. In such case, the process of stages 60-73 and 75-80 may be followed by each machine 10 individually for the section of the structure 110 they are manufacturing.

Further, the process of stages 60-73 and 75-80 is described with the machine 10 fixed at one location at the work site 100. In some instances, it may be desirable or necessary for the machine 10 to move from one location to another while manufacturing the structure 110. In such case, stages 67-73 and 75-80 may be utilized at each subsequent location to which the machine is moved.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A system for additive manufacturing a structure at a work site, the system comprising:
a mobile implement system having a linkage assembly including a nozzle, the nozzle being configured to deposit sequential layers of material to form the structure;
an implement system pose sensor for generating implement system pose signals indicative of a pose of the mobile implement system; and
a controller configured to:
access a site map of the work site;
access a model of the structure to be manufactured;
access a kinematic model and operating characteristics of the mobile implement system;
determine a plurality of potential poses of the mobile implement system at the work site based upon the site map and the model of the structure;
for each potential pose, determine a plurality of potential paths of the nozzle to form at least a portion of the structure by depositing a plurality of sequential layers of material based upon the site map, the model of the structure, the kinematic model and operating characteristics of the mobile implement system;
select a desired pose of the mobile implement system from the plurality of potential poses and a desired path of the nozzle from the plurality of potential paths;
determine a first sequence and rate of operation of the mobile implement system based upon the desired path of the nozzle and the kinematic model and the operating characteristics of the mobile implement system, the first sequence and rate of operation of the mobile implement system causing the nozzle to follow the desired path while the mobile implement system is at the desired pose;
generate a movement command to move the mobile implement system towards the desired pose;
determine a current pose of the mobile implement system at the work site based upon the implement system pose signals;
determine a difference between the current pose and the desired pose;
generate a modified sequence and rate of operation of the mobile implement system based upon at least the difference between the current pose and the desired pose, the modified sequence and rate of operation of the mobile implement system causing the nozzle to follow the desired path while the mobile implement system is at the current pose; and
generate command instructions to move the nozzle along the desired path to deposit the sequential layers of material along the desired path to form the at least a portion of the structure.

2. The system of claim 1, wherein the controller is further configured to generate movement commands to move the mobile implement system to a second desired pose after forming at least a portion of the structure.

3. The system of claim 1, wherein the controller is further configured to access an optimization parameter and select the desired pose of the mobile implement system from the plurality of potential poses and the desired path of the nozzle from the plurality of potential paths based upon the optimization parameter.

4. The system of claim 3 wherein the optimization parameter is a lowest cost.

5. The system of claim 4, wherein the controller is further configured to determine a cost associated with moving the nozzle along each of the plurality of potential paths at each potential pose, the desired pose and desired path corresponding to a lowest cost pose and a lowest cost path.

6. The system of claim 5, wherein the cost associated with moving the nozzle includes a machine cost based upon a time of operation of a machine operatively associated with the mobile implement system.

7. The system of claim 3, wherein the optimization parameter is maintaining a continuous flow of material through the nozzle.

8. The system of claim 1, wherein the mobile implement system further includes a rotatable platform having the linkage assembly mounted thereon, the linkage assembly including a boom member operatively connected to the rotatable platform, a connecting member operatively connected to the boom member, and the nozzle.

9. The system of claim 8, wherein the implement system pose sensor includes sensors for determining relative positions of the linkage assembly.

10. The system of claim 8, wherein the boom member is pivotably mounted to the rotatable platform, and the nozzle is pivotably mounted on the connecting member.

11. The system of claim 1, further comprising an inspection system disposed adjacent the nozzle to determine a width of a portion of each layer of material after it exits the nozzle.

12. The system of claim 11, wherein the inspection system includes a light source configured to illuminate the portion of each layer of material after it exits the nozzle and a camera system to determine the width of the illuminated portion of each layer of material after it exits the nozzle, and the controller is further configured to compare the width to the model of the structure and change a speed of the nozzle along the desired path based upon a difference in width of the model of the structure and the width of the illuminated portion of each layer.

13. The system of claim 1, wherein the plurality of potential poses of the mobile implement system and the plurality of potential paths of the nozzle are determined at a location remote from the mobile implement system.

14. A method of depositing sequential layers of material to form a structure at a work site using a mobile implement system having a linkage assembly including a nozzle, the method comprising:
accessing a site map of the work site;
accessing a model of the structure to be manufactured;
accessing a kinematic model and operating characteristics of the mobile implement system;
determining a plurality of potential poses of the mobile implement system at the work site based upon the site map and the model of the structure;
for each potential pose, determining a plurality of potential paths of the nozzle to form at least a portion of the structure by depositing a plurality of sequential layers of material based upon the site map, the model of the structure, the kinematic model and operating characteristics of the mobile implement system;
selecting a desired pose of the mobile implement system from the plurality of potential poses and a desired path of the nozzle from the plurality of potential paths;
determining a first sequence and rate of operation of the mobile implement system based upon the desired path of the nozzle and the kinematic model and the operating characteristics of the mobile implement system, the first sequence and rate of operation of the mobile implement system causing the nozzle to follow the desired path while the mobile implement system is at the desired pose;
generating a movement command to move the mobile implement system towards the desired pose;
determining a current pose of the mobile implement system at the work site based upon implement system pose signals from an implement system pose sensor indicative of a pose of the mobile implement system;
determining a difference between the current pose and the desired pose;
generating a modified sequence and rate of operation of the mobile implement system based upon at least the difference between the current pose and the desired pose, the modified sequence and rate of operation of the mobile implement system causing the nozzle to follow the desired path while the mobile implement system is at the current pose; and
generating command instructions to move the nozzle along the desired path to deposit the plurality of sequential layers of material along the desired path to form the at least a portion of the structure.

15. The method of claim 14, further comprising generating movement commands to move the mobile implement system to a second desired pose after forming at least a portion of the structure.

16. The method of claim 14, further comprising accessing an optimization parameter and selecting the desired pose of the mobile implement system from the plurality of potential poses and the desired path of the nozzle from the plurality of potential paths based upon the optimization parameter.

17. The method of claim 14, further comprising determining a width of a portion of each layer of material after it exits the nozzle.

18. The method of claim 17, further comprising illuminating the portion of each layer of material after it exits the nozzle and determining the width of the illuminated portion of each layer of material after it exits the nozzle, comparing the width to the model of the structure, and changing a speed of the nozzle along the desired path based upon a difference in width of the model of the structure and the width of the illuminated portion of each layer.

19. The method of claim 14, further comprising determining the plurality of potential poses of the mobile implement system and the plurality of potential paths of the nozzle at a location remote from the mobile implement system.

20. A movable machine comprising:
a traction device configured to propel the movable machine about a work site;
an implement system associated with the movable machine and having a linkage assembly including a nozzle, the nozzle being configured to deposit sequential layers of material to form a structure;
an implement system pose sensor for generating implement system pose signals indicative of a pose of the implement system;
a controller configured to:
access a site map of the work site;
access a model of the structure to be manufactured;
access a kinematic model and operating characteristics of the implement system;
determine a plurality of potential poses of the implement system at the work site based upon the site map and the model of the structure;
for each potential pose, determine a plurality of potential paths of the nozzle to form at least a portion of the structure by depositing a plurality of sequential layers of material based upon the site map, the model of the structure, the kinematic model and operating characteristics of the implement system;
select a desired pose of the implement system from the plurality of potential poses and a desired path of the nozzle from the plurality of potential paths;
determine a first sequence and rate of operation of the implement system based upon the desired path of the nozzle and the kinematic model and the operating characteristics of the implement system, the first sequence and rate of operation of the implement system causing the nozzle to follow the desired path while the implement system is at the desired pose;
generate a movement command to move the implement system towards the desired pose;
determine a current pose of the implement system at the work site based upon the implement system pose signals;
determine a difference between the current pose and the desired pose;
generate a modified sequence and rate of operation of the implement system based upon at least the difference between the current pose and the desired pose, the modified sequence and rate of operation of the implement system causing the nozzle to follow the desired path while the implement system is at the current pose; and
generate command instructions to move the nozzle along the desired path to deposit the sequential layers of material along the desired path to form the at least a portion of the structure.
